(19) United States
(12) Patent Application Publication
(10) Pub. No.: US 2014/0377091 A1
(43) Pub. Date: Dec. 25, 2014

(54) PUMP FOR INJECTING A FLUID, AND IN PARTICULAR A MICROPUMP FOR USE DELIVERING A DETERMINED DOSE

(71) Applicant: COMMISSARIAT A L'ENERGIE ATOMIQUE ET AUX ENE ALT, Paris (FR)

(72) Inventors: Elisabeth Delevoye, Saint Egreve (FR); Jean-Pierre Nikolovski, Chatenay-Malabry (FR)

(73) Assignee: COMMISSARIAT A L'ENERGIE ATOMIQUE ET AUX ENE ALT, Paris (FR)

(21) Appl. No.: 14/345,510

(22) PCT Filed: Sep. 21, 2012
(86) PCT No.: PCT/EP12/68693

§ 371 Date: Mar. 18, 2014

(30) Foreign Application Priority Data
Sep. 22, 2011 (FR) 11 58458

(51) Int. Cl. F04B 43/09; F16K 31/00; F04B 19/00

(52) U.S. Cl. CPC F04B 43/095; F04B 19/006; F16K 31/005
USPC 417/322; 251/129.06

(57) ABSTRACT

A pump devoid of mobile mechanical parts and including a tank with a sleeve for dispensing fluid that remains fully open, but of which an inside capillary is too thin to allow for dispensing of fluid when idle. Recourse is therefore made to a resonator device with a piezoelectric exciter, that produces vibrations, in particular bending, of the sleeve to oblige the fluid to flow through it at a determined flow rate that depends on characteristics of the pump and of excitation. The assembly can be miniaturized and used as an implantable device, for example for treatment of hearing pathologies, to deliver a drug, or, in certain embodiments, also take samples of ambient fluid. A remote energy supply is possible.

### SUBJECT OF THE INVENTION

The subject of the invention is a pump for injecting a fluid, and can in particular relate to a micropump for injecting a determined dose of the fluid.

In a more detailed manner, it can relate to actuating devices for biology and health, in particular injector and microdosing devices, able to locally deliver volumes less than a microlitre with a resolution of a magnitude of the nanolitre of gaseous and liquid products of low viscosity by ultrasound means. The dose to be delivered is more preferably in the form of viscous liquid (gel) or highly fluid on the contrary, but can also be constituted of fine powder. The grains of the powder may be nanocapsules possibly imprisoned in a gel or a hydrogel. It can also be used for other applications, in particular, for depositing ink on surfaces or the nebulisation of essence, perfume, deodoriser or particular products in a closed enclosure or a room.

According to certain important particularities of the invention, the device for actuating does not have any mobile or deformable mechanical parts. The fluid can be injected continuously, with the dosage being obtained in an open loop by exploiting the duration and amplitude of activation or in a closed loop using a set value to be reached on the remaining level of the tank, with the level being deduced from the frequency offset of a characteristic resonance of the volume of the tank. The device can be used in particular for medical dosing devices inserted into the human body, in particular in the case of chronic dispensing of drugs at very low flow rates and over very long durations (typically more than 10 years).

### PRIOR ART

The actuating of the micropumps can be carried out in different ways, for example by emission of ultrasonic waves as in the case of this invention, but also peristaltically, electrostatically, thermo-pneumatically, or even electromagnetically. A presentation of these different actuating devices can be found in the document of D. J. Laser and J. G. Santiago entitled “a review of micropumps”, J. Micromech. Microeng. 14(2004), R35-64. Peristaltic pumps are the most appreciated for pharmaceutical dosage because, on the one hand, they avoid any contact with the product to be delivered, on the other hand, they are compact and consume little current. However, they are reproached for the repeated flow of the pipe which allows for the displacement of the fluid, which can generate a fatigue and even abrasion of the material and the pulling off of matter.

The devices that are the most similar to this invention are ultrasound pumps.

In this field, the state of the art provides for example the following reference:
WO 02081867 (A1) of George Keilman (priority of 9 Apr. 2001); the method is based on focusing a longitudinal wave in a chamber comprising an inlet with a large orifice in order to receive the fluid to be pumped and an outlet with a small orifice wherein the fluid must be pushed. The device uses a broadband transducer, which is not planar, focusing longitudinal waves in the outlet orifice, with the focusing able to result in a cavitation phenomenon. The flow rates are of a magnitude of several hundred millilitres per minute and the power levels in question of several hundred watts. In this configuration, the chamber has any shape which must not interfere with the focalising effect of the broadband power transducer. The chamber can however be profiled according to a parabolic shape in order to conjugate a planar wave at its focal point. The chamber retains in any case a tapered shape and more preferably conical and arranged so that the tapered end corresponds with the point of focusing of the longitudinal waves. The longitudinal waves are by nature progressive and in order for them to not be reflected in the enclosure or generate stationary waves, a plastic material must absorb them on the output side. The fluid penetrates into the enclosure on the transducer side. The principle of such an ultrasound pump resides in the dissipation of vibratory energy absorbed by the fluid at the focal point and which results in expulsing it through the small orifice. The concentration of energy is such that a cavitation phenomenon can be generated. In this case, the changes in phase of the liquid by micro-cavitations mechanically favour the expulsion of the liquid towards the outlet.

The main difference between the invention of G. Keilman and this invention is that in the latter, the structure constituting the chamber plays a fundamental role in the generation of the vibratory mode on the ejection nozzle, because in this invention the chamber is in fact a full solid cavity conveying bending waves. Its mechanical excitation is carried out at the resonance frequency of the full cavity. The resonator constituted as such furthermore produces a mechanical amplification of the ejection nozzle. And in this invention, the fluid absorbs much less energy than in that of G. Keilman. Moreover, the pumping is here obtained not through dissipation of energy in the fluid but through a lateral and centrifugation compression phenomenon generated by a particular movement of the ejection nozzle. Finally, in the case of the invention of G. Keilman, the broadband operation and the recourse to cavitation substantially reduce the energy efficiency of the acoustic pump, which therefore is not suitable to be miniaturised, implantable and usable with a limited source of energy. The increase in temperature is moreover not acceptable in a product intended to deliver pharmaceutical products.

Different non-ultrasound piezoelectric devices can also be encountered for carrying out an accurate dosage of drugs by micropump. This is in particular the case with patent FR 2650634 (A1) of Harald Van Lintel of 7 Aug. 1989. In this micropump, the pumping is obtained thanks to the deformation of a plate using a piezoelectric pellet. The periodic deformation of the piezoelectric plate causes a periodic volume variation of a pumping chamber delimited in a plate made of a material able to be machined by photolithographic methods. The outlet of the pump is sealed off selectively by a diaphragm valve which is in direct communication with another valve through the pumping chamber.

The flow rates reached are from 30 to 60 μl/min for differential pressures (output less input) of a magnitude of 60 cm for water height. This method is compact and adapted for the dosage of insulin, but it is not ultrasonic and its suction principle is different from the device according to the invention which uses an alternative centrifugation that may be combined with a projection effect. This method encounters moreover limitations linked to the possible backflow of the product.

In the field of implantable dosing devices, the patent of Thomas Lobl and al. WO2007133389 (A2) (filed by Neurosystec Corp.) sets the specifications of a dosing device administering a pharmaceutical agent in the inner ear using a flexible duct fixed to the entrance of the middle ear.

Patent WO 2011/109735 (A2) filed by Cornell University can also be mentioned and which describes a cannula for delivering a liquid drug that can be set into vibration by various piezoelectric transducers, of which certain ones act directly on it by being fixed to it. No particular vibration mode is mentioned, and it seems that the vibrations assist the flow of the liquid by the cavitation that they induce in front of the internal surface of the cannula, and that their effect sought is above all to transmit the vibrations to the tissues of the living organism receiving the drug, which are adjacent to the cannula in order to assist the diffusion of the drug.

In certain cases, a device for administering drugs includes an implantable osmotic pump connected to a housing containing a drug, with this housing connected to a needle, to a cochlear implant or to another type of component for the administration to the target tissue. In certain embodiments, a subcutaneous orifice receives a liquid from an external pump. Said orifice is connected to a needle or other component for the administration of one or several drugs to the target tissue. Solid and liquid drug formulas can be used. In embodiments that use solid drugs, a separated drug vehicle (such as physiological serum) can be used to dissolve a portion of the solid drug, with the drug-loaded vehicle then being administered to the target tissue. The utilisation of solid drugs combined with a separated drug vehicle is a way to resolve the insufficient autonomy of an osmotic pump. The non-rechargeable drug is stored in the form of solid pellets and will dissolve slowly in a neutral fluid which can be refilled via a standard access orifice.

However, these dosing devices are confronted with the following problems:
a fluctuation in the concentration of substance depending on the progressive dissolution of the pellets;
the impossibility of changing the therapeutic formulation without a surgical operation, which gives rise to an intrinsic problem in the case of chronic use over very long durations (10 to 20 years).

This type of problem can be resolved with this invention in the sense that the pump can also act as a mixer by centrifugation of the carrier fluid once the powder is introduced.

### GENERAL OBJECT OF THE INVENTION

A problem to be resolved therefore relates to the micro-dosage (less than the microlitre, or 1 mm³) and more preferably the dosage of a volume with a resolution of a magnitude of the nanolitre of a product contained in a buffer tank of small size containing a typical total volume of a magnitude of the millilitre, but which can typically reach 10 ml. The tank can be housed in a supporting structure such as a case or the body of a stylus or for the medical field, in a biocompatible housing that can be implanted under the skin or even behind a bone wall. The tank can be refilled.

The product is more preferably a low viscous liquid or a liquid initially viscous but of which the viscosity decreases very locally on the ultrasound mechanical amplification following an increase in temperature caused by the viscous damping of the ultrasonic vibrations in contact with the product. The amplitude of the vibrations can be chosen in such a way that the heating of the fluid remains at a permissible degree, which is precious for delicate products such as drugs. The dosage is triggered either automatically and repeatedly if the device comprises an on-board source of energy that provides it with sufficient autonomy between two dosages, or punctually, by control, at the time when the device is subjected to ultrasound radiation that allows it to extract the energy that is sufficient to set it into operation. The energy recovery can be carried out remotely through a wall or transcutaneously by conventional inductive method or by ultrasound method.

In the case where the application requires, in particular for the nebulisation of flammable essence, the device according to the invention can accept high operating temperatures typically above 300° C. in the nebulisation zone. Finally, the ultrasound principle used does not make use of the electrostatic forces that can be found in the electro-fluid devices, and is not influenced by them. However, the dosing device can be covered by a hydrophilic layer in the tank and in the feed capillary to the ejection nozzle and hydrophobic in the zone of ejection or nebulisation orifice for a drop.

Another problem to resolve is more generally to make the pump compatible with biological applications, and in particular to allow it to be implanted without danger inside a living body with a stable operation, a sufficiently reduced volume, and during long operating times without replacement, which excludes any mechanism that can break down or that requires maintenance.

Another problem to resolve is to extract a dose from a tank designed so that no static leakage rate is possible and constitute drops rather quickly in order to prevent any evaporation in the ambient medium (this stands out as such from osmotic pumps). The tank is not necessarily under pressure or, in the case of implantation, necessarily hermetic in which case anti-bacteria or even anti-virus filters can protect the content. It is possible to use one or several one-way valves in such a way as to allow a flow only during the extraction of fluid and with the condition of inducing a pressure greater than a threshold (for example the Codman Hakim precision valves developed in the framework of hydrocephalus have pressure thresholds set as low as 10 mm H₂O and which can be adjusted between 30 mm and 130 mm H₂O (www.pedsneurosurgery.org/codman.pdf).

In the case of implanted systems another problem to be resolved is the robustness to the air bubbles in particular for a dispensing in the gaseous medium of the middle ear (37° C. saturated with moisture) while implantable pumps are in general designed to dilute an active substance in one of the body fluids (blood, lymph or other).

In order to resolve these problems, a dosing device is proposed that is able on the one hand to capture and convert a vibratory energy transmitted through a wall, for example the dermis and the bone, or (in other applications) a glass plate, a plastic, a concrete wall, a sheet metal in order to produce therefore its electrical power supply, on the other hand a high-efficiency injector capable of delivering a dose of the product contained in the tank using an ultrasonic vibration injector. In typical applications in biology, the tank contains a volume of approximately 1 ml in the form of a liquid, a gel, or a powder, able to provide 1000 to 1 million doses.

It is generally suitable to avoid the audible noises generated by the actuator regardless of its usage, as a dosing stylus, injector via centrifugation or nebulisation generated by the cavitation, or as an implantable device, able to be coupled to a bone wall. For this the dosing device operates in an ultrasound range between 20 kHz and 20 megahertz, making it possible moreover to resolve the problem of the miniaturisation in order to render the dosing device implantable and able to deliver small doses and finally to reduce the electrical consumption.

In the current microdosing systems, in particular for drugs, implantable pumps and dosing devices make it possible in general to refill the tank and supply via a transcutaneous operation inductively. And most of the pumps described in the state of the art do not provide an indication as to the means of electrical power other than the recourse to an on-board source of energy which may be rechargeable or a power supply via an inductive coupling. This method is not always suitable for the problem to be treated in particular in the case where the patient has to undergo an MRI (magnetic resonance imaging). Moreover, outside of applications for biology and health, it can be interesting to have a power supply other than inductive especially if the wall is metal. The acoustic pump described in this invention can include an acoustic means of piezoelectrically transforming a vibratory energy transmitted through the wall, skin or bone into electrical energy for supplying the pump. The piezoelectric convertor uses a piezoelectric layer that can operate in receiving mode in order to convert the vibratory energy. In an alternative embodiment, this layer deposited on the top portion of the tank opposite the ejection nozzle can also operate in transmitter mode in order to check the level of the tank and by difference the volume delivered. The measuring of the dose is carried out by analysis of the frequency shift of a frequency component characterising the volume of fluid available.

In the particular case of treating certain pathologies with active substances that are toxic for other parts of the organism, a local dispensing of the drugs is required. This is the case for certain substances that must be conveyed directly to the interior of the middle ear for the inner ear as some are toxic in particular for the brain and therefore cannot be administered by the other methods. The invention has a great importance for such applications.

### GENERAL DISCLOSURE OF THE INVENTION

In a general form, the invention relates to a pump for injecting a fluid, comprising a tank or fluid, a sleeve for the flow (or extraction) of the fluid outside of the tank and a device for controlling the flow, comprising a resonator arranged to apply flexural ultrasound oscillations to the sleeve, characterised in that the resonator comprises a piezoelectric transducer and a piezoelectrically deformable solid that is subjected to an oscillation under the effect of the transducer, said deformable solid thinning towards the sleeve.

The flow of the fluid outside of the tank is accomplished by progressing in a channel or a thin duct, often called a capillary in the rest of this description, which extends in the sleeve and opens to the exterior.

The dispensing of the fluid by oscillations of the sleeve that is always open by a piezoelectric resonator avoids any mobile parts in the pump and therefore makes it possible to use it favourably in a prosthesis for long durations. The absence of mobile mechanical parts also makes the pump perfectly reliable. The use of bending modes of the entire sleeve by a deformable solid of which the position, the shape and the behaviour are fully known makes it possible to determine the quantities of fluid delivered with high precision, contrary to the devices wherein the vibrations are applied randomly or unforeseeably by transducers placed without principle in the device. Despite the permanent opening of the sleeve, the finesse of the duct of the sleeve guarantees that no accidental dispensing of fluid will occur when idle. Finally, the pump can be adjusted by judiciously choosing its dimensions and control parameters, in particular the amplitude and the frequency of the vibrations, in such a way as to allow for very low dispensed flow rates. If required, a long duration of use of the pump is obtained even if it is of low capacity. An important advantage of the invention is in the use of a solid transmitter of vibrations from the transducer to the sleeve and which thins towards the sleeve, which results in that it concentrates the vibratory energy and amplifies the deformations of the sleeve without a large consumption of energy.

It will be shown that an important means for guaranteeing the presence of the flow of the fluid outside of the tank when the resonator is active consists in a sleeve that tapers without ceasing into sections from the tank to the free end.

Advantageously, the piezoelectrically deformable solid is a ring surrounding the sleeve and excited by a circular electrode divided into two sectors supplied by the same oscillating electric signal, but in phase opposition: this arrangement very conveniently generates the flexural oscillations of the sleeve.

The ring can be connected to the sleeve, by being distinct from the tank. In particular in this case, it can then be connected to the sleeve; moreover, the sleeve can taper towards the free end, likewise the ring can thin from a peripheral portion towards the sleeve; all of these arrangements facilitate the oscillations by increasing their amplitude.

The ring can also be part of a surface of the tank to which the sleeve is fixed, with the operation of the invention then being very different.

The sleeve can carry a flared nozzle at its free end in order to favour the delivery of the fluid by calibrated droplets.

The delivery of the fluid can also be guaranteed by a flexible tube surrounding the sleeve, wherein the sleeve opens, which comprises a free end that has an opening outside of the pump with reduced section in relation to a main portion of the flexible tube that contains the sleeve, and the resonator is arranged in order to apply flexural oscillations also to the flexible tube: the reduced orifice of the flexible tube, possibly obtained by a heat-shrink effect of the flexible tube made for example of polyethylene (PE) or polytetrafluorethylene (PTFE) or fluorinated ethylene propylene (FEP) or perfluoroalkoxy (PFA) with shrinkage ratios of 1.7/1 to 1.3/1 during its fastening to the sleeve by heating to a temperature of at least 210° C., then plays the same role as the tapering section of the capillary in other embodiments; the capillary can then be with uniform section without disadvantages.

The sleeve can be fixed to the tank rigidly, or it can be connected to it via a hose, in the case where it is supported by the resonator.

A particular embodiment of the invention authorises an inverse operation of the pump, i.e. an aspiration of ambient fluid then replaces the delivery of the fluid. Such an embodiment can be useful when a drug has to be applied temporarily, or when a sample of ambient fluid must follow or precede the delivery of the fluid contained in the tank. The sleeve then comprises two portions as a protruding extension on either side of the ring, dissymmetrical and the capillary passes through both of them. A system of valves can direct the fluid extracted towards a recipient other than the main tank.

The choice of the control frequency will preferentially control the oscillations of one of the two portions of the sleeve, and therefore the direction of flow of the fluid through the sleeve.

In an alternative embodiment, the sleeve comprises two portions as a protruding extension on either side of the ring, dissymmetrical and the capillary passes through both of them, and a middle portion joining said protruding portions, and the resonator also comprises two portions which are dissymmetrical and superimposed, respectively connected to said protruding portions, and between which the middle portion extends.

In the two cases, it is advantageous that the pump include a flexible tube surrounding each of the portions of the sleeve, which opens therein respectively, with each of the flexible tubes comprising a free end having an opening respectively outside of the pump and in the tank, with the opening having a reduced section in relation to a main portion of the flexible tube that contains the portion of the sleeve, and that the resonator be arranged in order to apply flexural oscillations also to the flexible tubes. As in a preceding embodiment, the flexible tubes favour the flow of the fluid in the desired direction.

According to another improvement, the pump can include a device for measuring the level of the fluid in the tank, which can include two sectors of the circular electrode, and a transducer located at a location of the tank opposite the resonator.

According to another type of improvement, wherein it is sought to prevent the inertia of the fluid from absorbing the vibratory energy of the resonator when the latter is part of the surface of the tank, the surface of the tank to which the sleeve is fixed is conical in such a way that the tank is convex, and a membrane extends in the tank by separating the fluid from said face. The membrane then isolates the fluid from the resonator.

The flow rate can also be regulated by a free valve between a piercing of the membrane facing the sleeve and an end of the sleeve opening into the tank.

Another possibility consists in providing the pump with a cover with an edge attached to the tank, covering the sleeve and provided with an orifice in front of the free end of the sleeve, which protects the sleeve. The orifice of the cover can then contain a free ball in a housing constituting the orifice, in order to correct the delivery of the fluid to the outside. Or again, the cover can delimit a housing forming a reserve of an additive to the fluid, which is delivered at the same time as the latter thanks to the vibrations, with a determined content of the mixture.

According to a very important operating mode, since it greatly facilitates the delivery of the fluid, the resonator is arranged to also apply axial oscillations to the sleeve. It has been observed that the superposition of the axial oscillations on the flexural oscillations, especially when the axial oscillations have a dual frequency of the flexural oscillations, favoured the flow of the fluid by the capillary.

Another manner to facilitate the transport of the fluid in the capillary consists in providing the pump with a needle fixed to the tank and extending in the capillary.

Finally, in a construction of the invention which is also important, the pump comprises a power transducer converting an electrical energy into pressure waves in an adjacent medium, a receiving transducer, also adjacent to said medium, converting the pressure waves into electrical energy is fixed to the tank, and connected to the resonator in order to control it.

### LIST OF FIGURES

The preceding notions shall now be developed while still describing in detail certain particular embodiments of the invention.

These modes are provided for the purposes of information on the various aspects of the invention, but it is manifest that the latter can be constructed in another manner, with different embodiments, obtained for example by combining elements of the embodiments effectively described. The following figures shall be referenced:

FIG. 1 is a view of a first embodiment of the invention;

FIG. 2 shows the electrodes;

FIG. 3 shows a second embodiment;

FIG. 4, a third embodiment;

FIG. 5, a fourth embodiment;

FIG. 6, a fifth embodiment;

FIG. 7, a sixth embodiment;

FIG. 8, a seventh embodiment;

FIG. 9, an eighth embodiment;

FIG. 10, a ninth embodiment;

FIG. 11, a tenth embodiment;

FIG. 12, an eleventh embodiment; and

FIG. 13, a particular embodiment of the electrodes of the resonator.

### DETAILED DESCRIPTION

### General Characteristic Simple Embodiment

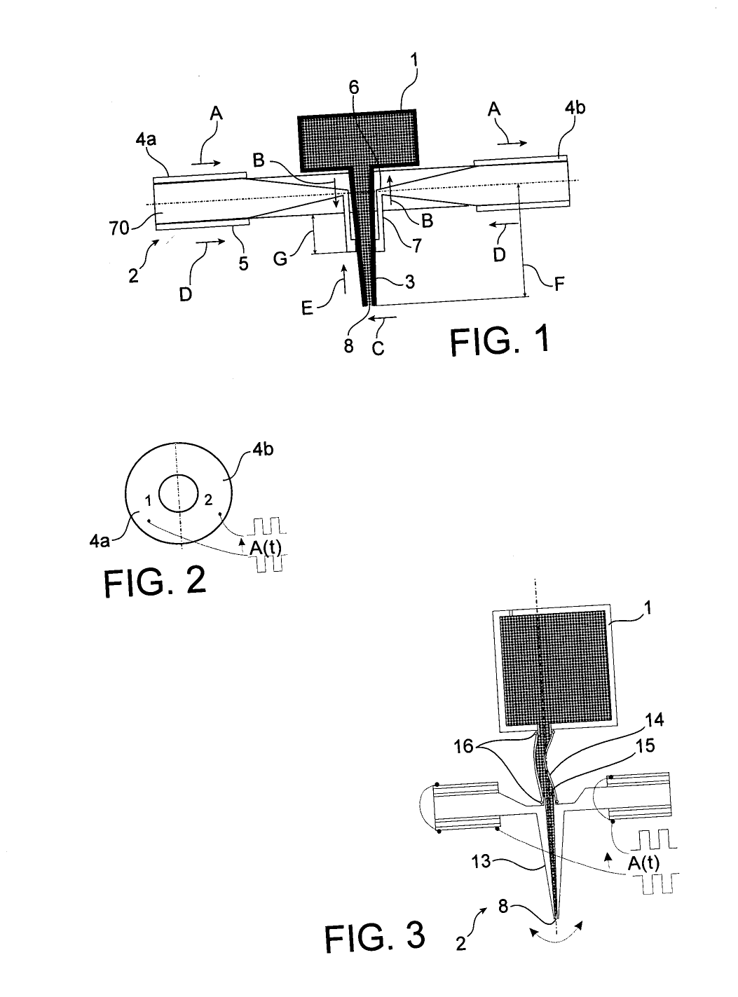

FIG. 1 shows the key points of the pump according to the invention. The pump integrates a tank 1 containing a fluid coupled to a resonator 2 by a hollow sleeve 3 as a flexible tube that can be conical or tapered. The resonator 2 is annular and surrounds the sleeve 3. It comprises a ceramic ring 70 that has on its periphery piezoelectric transducers that deform it when the electrical energy is applied to them. These transducers all include an external electrode controlled by an exterior power supply, an internal electrode and a layer of piezoelectric material that deforms according to the electric field that the electrodes apply to it. The electrodes are fixed on the two surfaces of the piezoelectric layer, the internal electrode is also fixed to the ring 70, and the external electrode gives onto the outside of the resonator 2. The deformations of the piezoelectric layer are therefore transmitted to the ring 70. In this embodiment as in others, the resonator 2 is separate from the tank 1, but it is actually connected to it, for example by a cylindrical ring. The deformations that the transducers apply to the ring 70 of the resonator 2 are in the radial direction, towards the inside or the outside according to the sign of the electrical charges applied to their electrodes. The transducers include a pair of semi-circular transducers 4a and 4b (FIG. 2) fixed to the upper surface of the ring 70, and which can be controlled by alternating current in phase opposition. The deformations (A) that they subject the ring 70 to are therefore in opposite directions on opposite radiuses. The ring 70 is deformed in the same way at the upper periphery where it is connected to the transducers 4a and 4b, but its rigidity results in that these deformations induce at the central portion 6 of the opposite vertical deflections (B) of the sectors of the ring 70, which are respectively associated with the transducers 4a and 4b, and a lateral bending (C) of the sleeve 3, which swings it from one side then the other at each inversion of the direction of the current. This oscillation is an overall flexural oscillation according to which the entire sleeve 3 is deformed according to a natural mode or a superposition of natural modes, in general with the first natural mode corresponding to a displacement of all of the regions of the sleeve 3 in the same radial direction with an amplitude increasing towards the free end, and it gives rise to the flow of the content of the tank 1 as for which details shall be given in what follows. A second transducer having an external electrode 5 and an internal electrode earthed is established under the ring 70, facing transducers 4a to 4b, but its constitution is different since it is continuous on a circle and therefore subjects the ring 70 to radial axisymmetric deformations (D). In the same way as with the transducers 4a and 4b, these corresponding deformations generate a vertical deformation component of the centre of the piezoelectric ring, but which is uniform on its circumference, in such a way that they induce a vertical movement (E) of the sleeve 3. Here again, the application of the alternating current produces an oscillatory movement. This axial mode of vibration, that will also be referred to as speaker mode since it results in a beat of the lower surface of the tank 1 to which the sleeve 3 is connected, can also facilitate the flow of the fluid outside of the tank. It must however be emphasised that a particularly favourable configuration is obtained by cumulating the two excitation modes, with the axial or vertical oscillation frequency of the sleeve 3 (according to the movement E) being twice that of the flexural oscillation of the sleeve 3 (according to the movement C), since then the flow is greatly facilitated, and the flow rate outside of the tank 1 more substantial.

The ring 70 has a thinned central region 6 creating a mechanical amplification of the vibration. The central region 6 of the resonator 2 comprises a tubular section 7, in contact with the sleeve 3 tapered towards its free end of the sleeve, wherein is located an ejection nozzle 8, and not far from this free end. The movements of the centre of the ring 70 are therefore transmitted to the sleeve 3 by tubular section 7, which converts the especially vertical movement B into an especially horizontal movement C by leverage effect. This disposition also makes it possible to connect the resonator 2 to a more tapered location constituting a weaker mechanical load of the sleeve 3 and therefore to bend it more easily, while still transmitting oscillations that are more substantial than those of the central region 6, again thanks to the lever arm procured by the tubular section 7; the thinning of the central region 6 itself makes it possible to increase these oscillations thanks to the decrease in its rigidity.

The physical operating principle of the pump can be presented in two different ways. The first consists in saying that when the resonator 2 is in resonance flexing with the tipping of the assembly of the sleeve 3, with a swinging movement (B and C) corresponding to the first natural bending mode, the sleeve 3 stretches by curving and a portion of the fluid is driven towards the end. During the return movement, the sleeve 3 moves back through the vertical, the stretching is then minimal. The situation is such that after having easily progressed towards the free end, less loaded, towards the ejection nozzle 8, it is impossible for the fluid to rise to the base of the sleeve 3 which is much more loaded with fluid and therefore to rise towards the top portion of the tank 1 (with the liquid being by hypothesis incompressible in the absence of air bubbles in the sleeve 3). Indeed, the section of liquid that must be pushed in order to rise in the sleeve 3 is greater than that what must be displaced to go down it. This property is reinforced if the capillary channel inside the sleeve 3 is also tapered towards the free end. The small volume of liquid at the end subject to a substantial load, must descend towards the ejection nozzle 8 by triggering a squirt in the only direction possible which is towards the narrowest end where the load is the lowest, i.e. towards the exterior. Then, with the alternating of the swinging movements, another volume is driven towards the free end at each tipping, which will be in turn expulsed during a return to the vertical alignment of the end. There are therefore two squirts, i.e. two ejections, or two streams of liquid, per ultrasound period.

The second way to explain the operating principle of the pump is without a doubt as easy to understand and to model as it consists in saying that the sleeve 3 constitutes a rotation arm around an axis located at the base of the sleeve. For small swinging movements (of a few microns), the tipping of the sleeve 3 by a few millimetres in height, is similar to a rotation. The rotation of the sleeve 3 is inverted twice per ultrasound period. The masse of volume of liquid contained at the end of the sleeve 3 therefore undergoes an acceleration that is both tangential and centrifugal of which the force can be calculated and which, conveyed to the internal surface of the capillary channel, defines the intrinsic suction pressure of the pump. Knowing that the sleeve 3 carries out coming and goings at the resonance frequency of the resonator 2, the centrifugal and tangential acceleration is maximal at each time that the sleeve 3 passes through the vertical position. This explanation joins in its conclusions the preceding explanation, i.e. the production of a squirt twice per ultrasound period. Furthermore, it suggests that it is not necessary to provoke a strong dissipation of vibratory energy in the fluid in order to trigger the pumping. The process can have good energy efficiency. Finally, it makes it possible to think that a centrifugal acceleration threshold exists making it possible to overcome the hydrophilic or hydrophobic forces that result in a surface tension that could retain the liquid and allow it to progress. No cavitation of the fluid is required.

### Particular Example of the First Embodiment

In a particular embodiment the tank 1 and the sleeve 3 are integrated, and the sleeve 3 is a conical tube inserted by force into the tubular section 7 of the resonator 2. The fluid located at the end of the sleeve 3 undergoes a lateral and centrifuge acceleration that propels it to the output of the ejection nozzle 8 with inner diameter 0.5 mm. The height of the acceleration arm is 21 mm between the average level of the resonator 2 and the ejection nozzle 8 (mark F). The resonator comprises a symmetrical thinning in its central region 6 that increases the amplitude of the vibration according to a bending mode. The internal electrodes in contact with the ring 70 are earthed. The piezoelectric ceramic of the transducers 4a, 4b and 5 is excited as a half bridge. Their internal electrode is earthed and their external electrode is excited by a symmetrical sinusoidal or square voltage. The piezoelectric ceramic can provide a second type of vibration in order to impress a movement according to the axis of the sleeve 3 and allow for the ejection of a single droplet which has formed at the end of the ejection nozzle 8 with tapered shape; there can then be two steps, a first wherein the droplet is formed slowly and increases in size at the end of the sleeve 3 to occupy the ejection nozzle 8 by means of transducers 4a and 4b, and a second step wherein the axisymmetric transducer generates an axial movement and propels the drop; this operation is more weakly obtained with flared ejection nozzles 8, forming a recipient and covered with a hydrophobic coating of which samples shall be seen further on.

The dimensions and the electrical power brought into play by this method of pumping makes this actuator compatible with all of the ultrasound pumps that apply this method. An alternative smaller in size and excitation power is described further on for an implantable use. It is possible to miniaturise further than in the exampled described.

The method of pumping via centrifugation lends itself well to the calculation of the pressure or of the vacuum of the pump. It is assumed that the fluid is initially inserted until the end of the conical tube forming the sleeve 3.

This first prototype is carried out with a resonator 2 with an outer diameter 50 mm and an internal radius of 2 mm of the ring 70 of which the tubular section 7 is pierced at 1.3 mm in diameter and at a height of 5.5 mm under the lower line of the ring 70 of the resonator 2 (mark G). It produces a resonance frequency of 26 kHz (period of 38 μs) and an amplitude of lateral vibration at the end of the sleeve 3 of 1.6 μm peak-to-peak, which is about 5 μm peak-to-peak at the end of the sleeve 3 of height 21 mm. The centrifugal acceleration is therefore maximal when the movement of tipping is at the vertical. If U₀ is the amplitude of lateral deviation, f₀ the resonance frequency of the resonator 2, a_{c} the centrifugal acceleration, R the height between the base of the sleeve 3 and by considering the elementary volume of fluid located at the end of the ejection nozzle, there is:

$$U ( t ) = {U}_{0} Sin ( 2 π {f}_{0} t )$$

$${a}_{c} = \frac{4 {π}^{2} {f}_{0}^{2} {U}_{0}^{2}}{R} {Cos}^{2} ( 2 π {f}_{0} t )$$

with U₀=2.5 μm,

f₀=26 kHz,

R=21 mm,

or here: a_{c}=2 m/s′. The centrifugal acceleration reaches about 20% of the acceleration of the gravity when the sleeve 3 passes through the vertical.

The lateral deviation also generates a tangential acceleration component (a_{T}=R/U₀ a_{c}). This component is R/U times more powerful than the centrifuge component, which is approximately 8000 times more powerful. This acceleration is able in certain cases to generate a drop in pressure on lateral walls that is sufficient to create a cavitation phenomenon on the lateral wall of the side of the direction of tipping. But above all it generates an inertial flow of the fluid against the lateral walls of the sleeve 3, which flushes it in the axial direction. The reduction of the section of fluid towards the free end of the sleeve 3 is as such a condition that favours the progression of the fluid towards the end.

The strong acceleration undergone by the fluid is required in order to push it through a thin capillary. For a thin capillary, that does not authorise a flow of the fluid in static conditions, and which therefore can always remain open, without a valve of any type and which constitutes an advantageous embodiment of the invention, a simple acceleration of a few “g” is not enough to expulse a drop. The pump is therefore idle in a closed state, i.e. the content of the tank 1 does not flow although the sleeve 3 remains open. Thin capillary means a capillary wherein the fluid does not spontaneously flow by the effect of gravity, with the capillary forces therefore being predominant. In the absence of capillary bridges or capillary forces, for example due to a surface condition that is not perfectly smooth, so that there is a natural flow, the gravitational force (or if needed its projected value) must be greater than the surface force of which the amplitude and the angle with the wall of the tube depend on the wettability of the fluid and on the hydrophilic or hydrophobic surface treatment of the wall. In order for there to be spontaneous flow, it is therefore sufficient for the diameter to be sufficiently large so that the gravitational force finishes by exceeding the surface force. As such, the diameter of the capillary will be generally less than 1 mm, even less than 0.5 mm. It will typically be between 0.1 and 0.5 mm.

A valve can however be added, in particular in the case of a difference in gas pressure to be provided between the inside of the tank and the outside medium, in order to prevent any untimely flow (see an embodiment further on) and any leakage by simple capillarity and even any effect of evaporation.

In sum, an elementary volume of fluid at the end of the conical sleeve 3 undergoes a periodic pressure-vacuum of which the module reaches 16,000 Pa; this pressure is lateral and slightly downstream.

The pumping is continuous or intermittent. In the case of the prototype that is shown here, an excitation with a duty cycle of 10% makes it possible to expulse 100 μl of liquid in 20 seconds into a sleeve 3 with an inner diameter 0.7 mm at the thinnest. The same 100 μl are expulsed in 2 seconds for a continuous emission. The ceramics are of the Ferroperm PZ26 brand, of thickness 0.5 mm and excited by an excitation voltage of 80 Vcc.

An intermittent pumping can be constituted for example of 100 periods at 26 kHz, which is 3.87 ms with a duty cycle of 10% or an intermittent rate of fire of 1/38.7 ms=25.8 Hz. Each packet comprises 100 periods with flexing of the end and 150 periods at the frequency 2×26 kHz=52 kHz, with up and down movement (axial) of the end.

As indicated hereinabove, the bending mode is sufficient to trigger the pumping of the fluid. The axial mode can furthermore affect the ejection of the fluid at the end of the nozzle 8 and according to its geometry. For a drop-by-drop ejection, a bending mode to progressively constitute the drop at the end of the tapered nozzle 8 can be combined with an axial mode to expulse the drop after it has been formed.

If this actuator is miniaturised, it is possible to reach, for example, a working frequency of 600 kHz for a diameter of the resonator 2 of 7 mm (about 30 times higher in frequency). The following estimations can be made:
the increase of the frequency reduces as much the amplitude of the vibrations and therefore the volume of each squirt. Therefore, if the frequency is multiplied by 30, the squirt volume is divided by 30, which places about 1 nanolitre per squirt;
the control electronics can be programmed to provide a predetermined number of squirts of 1 nanolitre.

In sum, for the expulsion to be effective, the following conditions can be indicated:

1) a liquid contained in the tank 1, which is connected to a flexible tube (the sleeve 3) inserted by force into an orifice of the resonator 2;

2) a back and forth bending movement of the end of the sleeve 3 and of its ejection nozzle 8;

3) a conical or tapered shape of the end of the sleeve 3 or of the ejection nozzle 8, creating a situation of a reduction in the mechanical radiation impedance (product of the section of the tank×height over a half-period×density×velocity of sound in the fluid) along the axis;

4) a free end able to reach a large amplitude of lateral deviation.

Having in addition an axial vibration with the dual frequency of the bending mode triggers an elliptical vibration of the internal surfaces and can facilitate the flow.

The phase shift between the two axial tilting frequencies must be adjusted so that the two effects are added together and that the fluid is pushed in the correct direction i.e. towards the end of smaller section of the tank (for a lateral movement in U₀ Sinus (2πf₀t) there is an axial movement in Uₜ Sinus(2πf₀t+φ) where Uₜ designates the maximum amplitude of the axial movement).

### OTHER EMBODIMENTS

FIG. 3 shows a slightly different embodiment of the invention, wherein the sleeve, now referenced by 13, is integrated with the resonator 2. As previously, it tapers towards the free end comprising the ejection nozzle 8 in order to increase its flexibility under the effect of the lateral acceleration forces and to as such favour the ejection of the fluid, and its opposite end is connected to the resonator 2. A hose 14 connects the tank 1 to the opening or embedded end (if machined monolithically with the resonator) of the sleeve 13 and as such allows for the flow of the liquid towards the exterior. The tank 1 and the sleeve 13 are provided with tips 15 and 16 whereon the ends of the hose 14 are inserted, and tightening rings 16 that maintain the assembly, which is however flexible enough that the lateral movements of the sleeve 13 are not prevented. A solution for fastening alternative to the tightening ring that reconciles tightening without blocking the sleeve 13 consists in using a heat shrinkable flexible liner with a narrowed portion between 1.1 and 2.5.

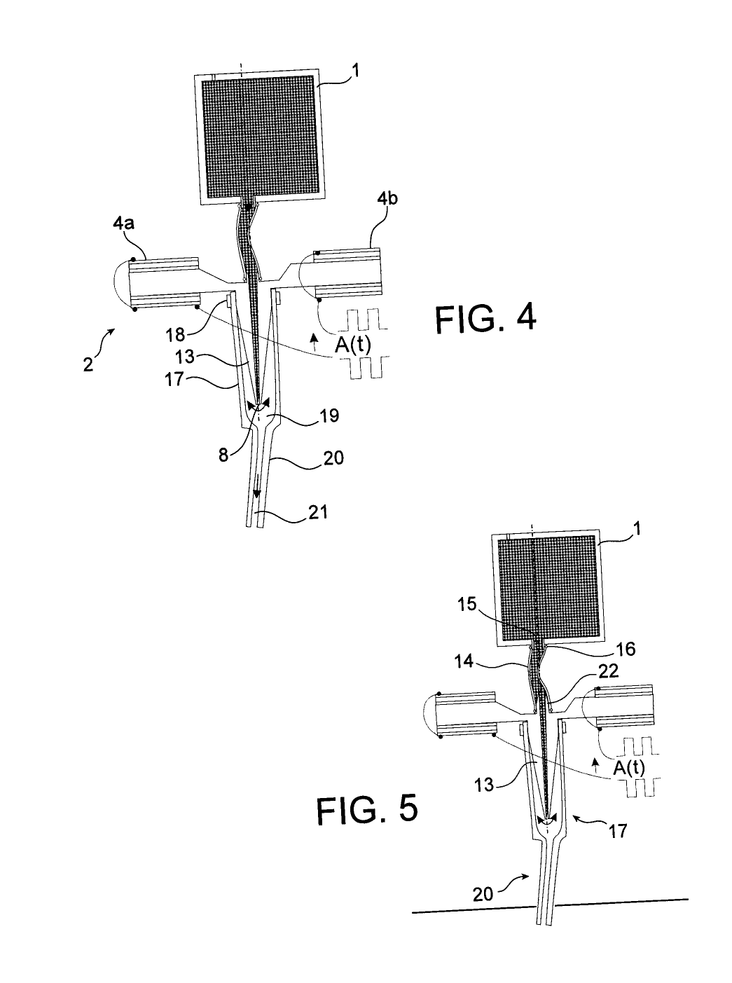

FIG. 4 shows an alternative embodiment, wherein an outlet hose 17 is inserted around the sleeve 13 and blocked on it by another tightening ring 18; it encloses an intermediate volume 19 that the fluid occupies after having left the nozzle 8 and before definitively leaving the pump. To this effect, the outlet hose 19 comprises a free end 20 comprising a capillary 21 through which the fluid exits the intermediate volume 19. The end 20 is long and thin enough to be subjected to the same horizontal oscillating movements as the sleeve 13 under the effect of the vibrations of the resonator, with an amplification due to its length and to its flexibility that are greater.

In the alternative embodiment shown in FIG. 5, the sleeve 13 is supplemented by an opposite sleeve 22 and as an extension, also fixed to the resonator 2, that penetrates into the inlet hose 14 and which also has the shape tapering towards the free end (here directed towards the tank 1), but of which the length is different from that of the sleeve 13. The resonance frequencies of the sleeves 13 and 22 are as such different, which makes it possible to reverse the direction of pumping according to the excitation frequency, if this frequency coincides with the resonance frequency of the sleeve 22: the free end 20 of the outlet hose 17 can then be plunged into an ambient fluid so that it is sucked towards the tank 1.

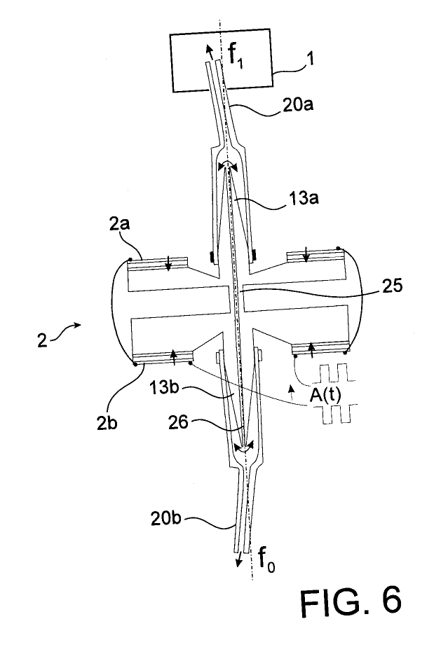

The same effect can be obtained with the embodiment of FIG. 6, wherein the resonator 2 comprises two superimposed rings 2a and 2b connected together by a hollow rod 25 that two sleeves 13a and 13b extend in opposite directions, a single capillary 26 passing through the sleeves 13a, 13b and the tube 25. Each of the sleeves 13a and 13b is fixed to one of the respective rings 2a and 2b. A hose 20a or 20b is engaged on each sleeve 13a or 13b, in the same way as the outlet hose 20 of the preceding embodiment. The fluid 20a opens into the tank 2, the fluid 20b to the exterior of the pump. The assembly is practically symmetrical except that the rings 2a and 2b have different thicknesses and therefore different resonance frequencies. By judiciously choosing the excitation frequency, one of the sleeves 13a and 13b vibrates at an intensity that is much greater than the other, which further imposes the direction of the movement of the fluid. As the connection tube 25 is thinner than the sleeves 13a and 13b, the acoustic coupling that it produces is low.

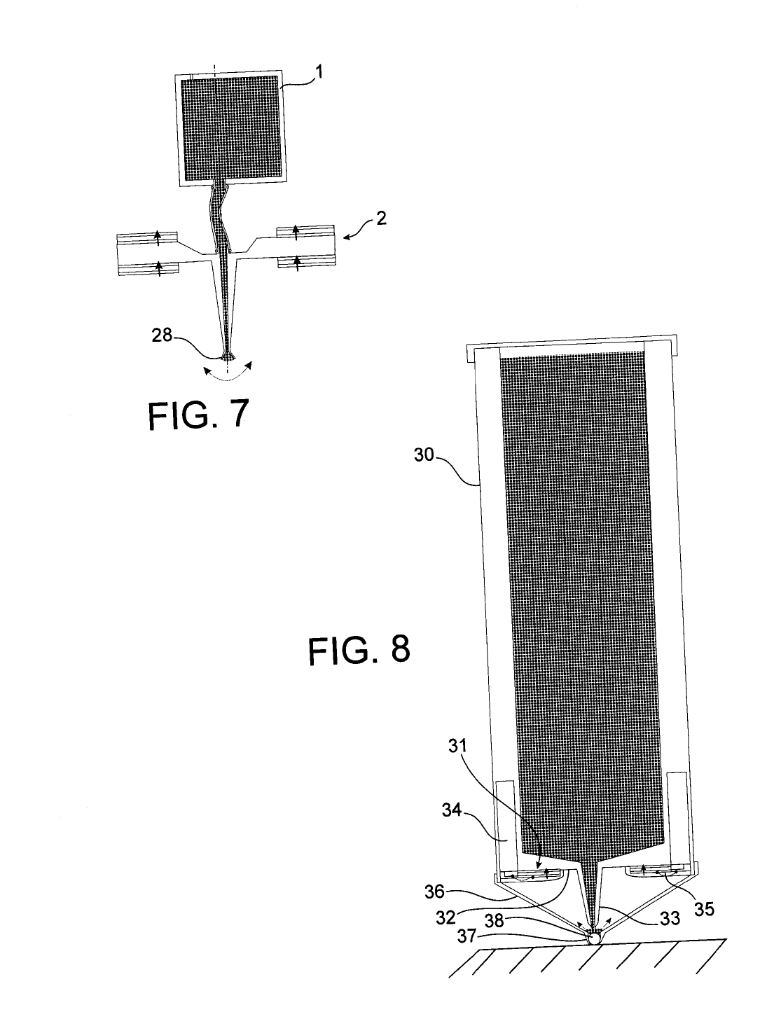

Another type of improvement, shown as an alternative of FIG. 3, appears in FIG. 7: the nozzle 8 is replaced with a nozzle 28 tapering towards the outlet, which allows a drop to increase in size before it is ejected by temporarily increasing the amplitude of vibrations and therefore the acceleration. A hydrophobic coating advantageously covers the inside of the nozzle 28 in order to give this effect. The device can be used as nebulizer. Note that the other embodiments also make it possible to deliver constant and known flow rates, but not necessarily in the form of drops.

Commentary will now be made on FIG. 8. The invention can be applied to the continuous delivery of fluids in utility applications wherein the fluid is for example ink or paint deposited on a surface made of paper, ceramic or other. The tank 1 here takes the form of a stylus 30 with an extended shape wherein the resonator, now 31, is embedded. It further comprises a ring 32 which constitutes here the lower surface of the stylus 30, and a sleeve 33 of a part with the wall 32, tapering downwards and the free end, and of which the inside capillary is also tapered. A flexible printed circuit 34 is wound in the wall of the tank 30 in such a way as to be adjacent to the resonator 31 and controls electrodes 35 in accordance with the preceding embodiments. The stylus 30 carries a lower cover 36 which protects the resonator 31 by covering it, of which the shape is conical and which carries at its top an orifice 37 with ball 38 located just below the free end of the sleeve 33. Similarly to what exists for ballpoint pens, the liquid delivered by the stylus 30 covers the ball 38 and exits the orifice 37 at a uniform flow rate. The bending mode of the sleeve 33 is typically associated with a resonance frequency of 600 kH. The excitation of the actuator lasts between 10 μs and 100 μs at periodic intervals, with the flexible printed circuit 34 comprising an excitation pulse control clock.

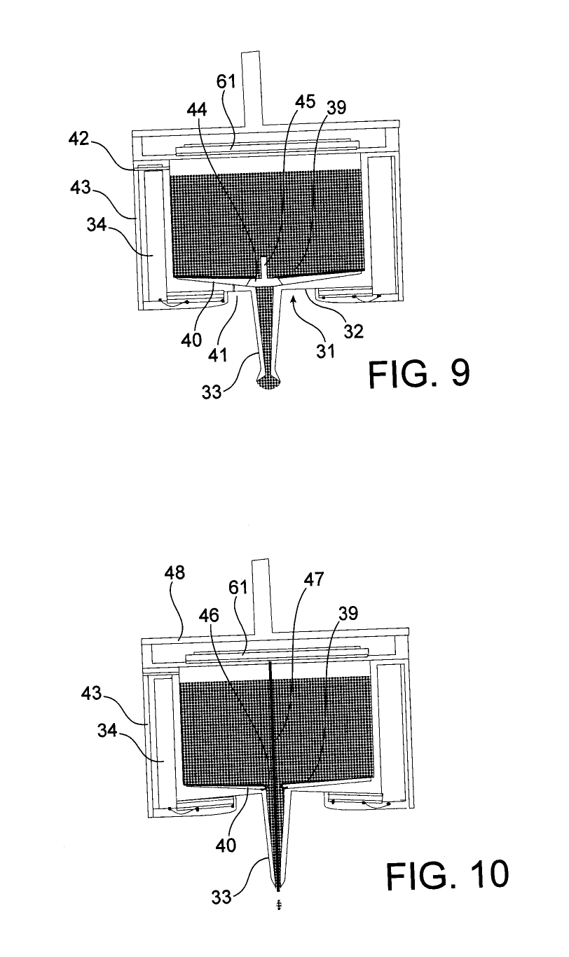

Other embodiments shall be described by means of FIGS. 9 and 10. When the resonator is integrated into the tank as in the preceding embodiment, a disadvantage that appears is that the liquid bears down on the resonator and limits the amplitude of its vibrations. This can be countered by the arrangement taken in the embodiments of FIGS. 9 and 10, wherein a membrane 39 pierced at its centre extends above the resonator 31 in such a way that an empty volume 40 exists between the ring 32 and the membrane 39. The ring 32 carries a hole 41 allowing the entry of ambient air into the empty volume 40; another hole 42 (also present in the other embodiments) passes through the upper wall of the tank, here 43, in order to communicate its content to the exterior and allow for the progressive flow of the fluid that it contains. A valve 44 occupies the centre of the empty volume 40 and covers the entrance of the capillary of the sleeve 33 in such a way as to avoid a direct flow of the fluid, which would fill the empty volume 40. The valve 44 is provided with a rod 45 that extends through the piercing of the membrane 39 and maintains it in place. When the resonator 31 is set into movement, the flexing vibrations of the sleeve 33 tip also the valve 44, which causes periodic clearances to appear with the membrane 39 and the capillary of the sleeve 33, as such allowing for a split flow of the fluid, of which a small volume therefore passes through the empty volume 40 at all times.

The embodiment of FIG. 10 differs from the preceding one in that it does not include the valve 44 and in that the membrane 39 is supplemented by a curved lip 46 surrounding the capillary of the sleeve 33 and isolating the empty volume 40 from the content of the tank 43. A needle 47 extends in addition in the duct of the sleeve 33 and in the tank 43, until the free end of the sleeve 33 and the bottom wall 47 of the tank 43. When the resonator 31 vibrates, the bottom wall 48 remains fixed, which slides the sleeve 33 along the needle 47 and favours the flow of the fluid, especially if the needle 47 is coated with a material that favours the wetting by the fluid (a hydrophilic material if the fluid is water). Indeed, the axial back and forth movement of the sleeve along the needle 47 favours the wetting and the displacement by capillarity of the fluid in the direction of the outlet. The embodiment of FIG. 9 is suitable for discontinuous streams of fluid (especially if it is provided, as it has been shown here, with the flared nozzle), while the embodiment of FIG. 10 is suitable for more continuous streams of fluid constituted of fine droplets. The surfaces of the empty volume 40 are advantageously covered with a hydrophobic layer (more generally with a non-wetting material) in order to counter the presence over time of the fluid; the inside of the sleeve 33 as well as the lateral and upper walls of the tank 43 are on the contrary coated with a material that favours wetting.

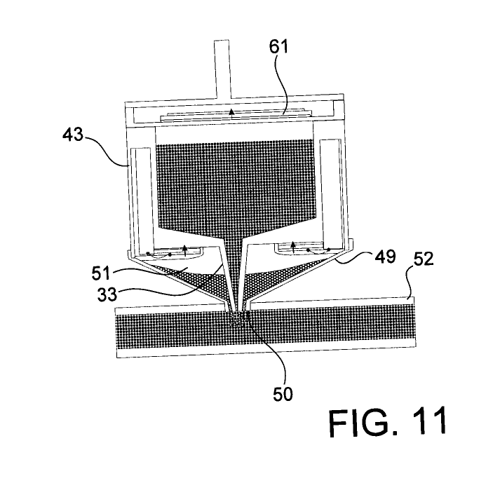

The embodiment of FIG. 11 shall now be considered. The tank 43 is provided with a lower cover 49 that is similar to the cover 36 of the embodiment of FIG. 8 and which likewise covers the sleeve 33, but which finishes on an orifice 50 surrounding the free end of the sleeve 33 and which forms a clearance with it. The inside volume 51 to the cover 49 is used and forms a reserve of powder which is evacuated little by little, simultaneously with the fluid contained in the tank 43, under the effect of the back and forth movements of the sleeve 33, and primarily of the components in the axial direction. This embodiment is shown installed on a duct 52, with the orifice 50 being arranged through a piercing of the latter, with the device thus regularly supplying additives to the contents of this duct 52.

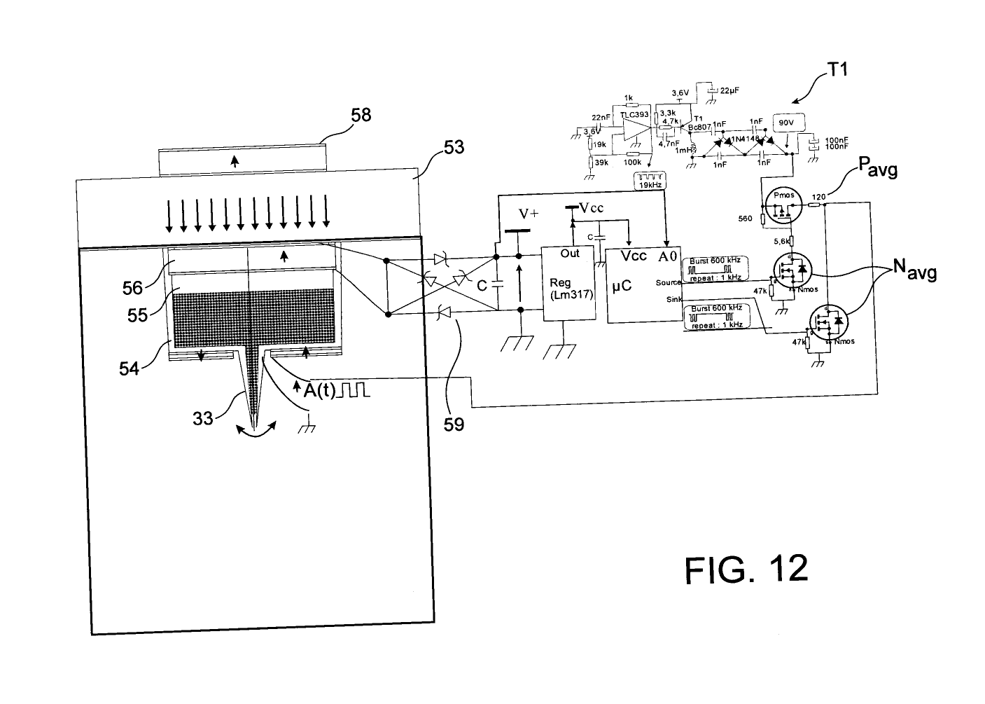

Commentary will now be made on FIG. 12. The exciter device can be separated from the rest of the pump, which is then located behind a wall 53, for example implanted under the skin or the bone of a living being. The device is then designed for the regular delivery of a drug or of another product for a long duration, possibly for several years, at a low dose. The tank 54 can then be refilled and its volume 55 unoccupied by the useful fluid is perhaps filled with gas under pressure or with gas at ambient pressure. A receiving transducer 56 is advantageously adjacent to the wall 53 and occupies the surface of the tank 54 which is opposite the sleeve 33, with the resonator 57 being constituted by the lower surface of the tank 54 as well as by electrodes connected to the receiving transducer 56. The receiving transducer 56 depends on a power transducer 58 placed to the exterior, on the other side of the wall 53, which transmits to it the excitation energy via longitudinal waves through the wall 53. The power transducer 58 communicates with the receiving transducer 56 by transmission of ultrasound waves through the intermediate medium. A power supply via rechargeable batteries is a possible alternative.

### Energy Recovery Through a Wall

The efficiency of the energy recovery depends substantially on the effectiveness of the piezoelectric conversion of the materials used and is then according to the dispersion of the acoustic energy during its propagation in a possibly heterogeneous semi-infinite medium. Through analogy with telecommunication transmission lines, mechanical impedance adaptation is evoked when two different acoustic propagation environments must be coupled. In certain cases, the difficulty of the coupling comes from the small coupling surface, while in other cases, the difficulty is due to the highly different nature of the two mediums, solid for one, liquid for the other. The problem that must be resolved has these two difficulties. They shall now be described somewhat more quantitatively.

The first notion is that of mechanical impedance. For an infinite medium, this rupture is characterised by the notion of intrinsic impedance of the mediums, Zᵢ, a product of the density p and the velocity V of the acoustic waves that propagate therein: Zᵢ=ρ^{V} is observed. The velocity V can be that V_{L} of the longitudinal waves or V_{T} of the transversal waves.

For a planar interface separating two non-viscous semi-infinite fluid mediums, characterised by their intrinsic impedances Z₁ and Z₂, the reflection coefficient of the acoustic power R of a planar sinusoidal acoustic wave in normal incidence at the interface is:

$$R = \frac{{P}_{R}}{{P}_{i}} = {[ \frac{{Z}_{1} - {Z}_{2}}{{Z}_{1} + {Z}_{2}} ]}^{2}$$

The transmission factor T of the acoustic intensity is:

$$T = \frac{{P}_{T}}{{P}_{i}} = \frac{4 {Z}_{1} {Z}_{2}}{{Z}_{1}^{2} + {Z}_{2}^{2}}$$

If the mediums have impedances that are very different, the major portion of an incident wave emitted from the medium 1 is reflected at the interface without reaching the medium 2.

If the mediums are both solid and liquid, reflection, refraction and conversion coefficients appear according to the angle of incidence.

Moreover, the absorbing of the acoustic waves, linked to the viscosity of the propagation medium, is also a factor that is to be taken into consideration. The power of one acoustic wave P(z) propagating according to the direction z, in a medium with a loss by viscosity characterised by a coefficient of viscosity η (with

$$T = \frac{\partial v}{\partial z} ,$$

where T is the constraint and v the velocity of the particles) can be expressed according to the formula

$$P ( z ) = {P}_{0} {e}^{- 2 α z}$$

$$α = \frac{η 2 π {f}^{2}}{2 {V}^{3} ρ}$$

α is often given in dB/cm. This coefficient increases with the square of the frequency f and is inversely proportional to the cube of the velocity of the waves. As the velocity of the longitudinal waves is practically twice that of the velocity of the transversal waves, the absorbing of transversal waves in a viscous medium is much greater than that of longitudinal waves. Soft plastics are part of this category.

The insertion rate shows the effectiveness of the piezoelectric transducer emitter thrust against the skin in converting the electrical energy into mechanical energy that propagates through the skin and the bone to a piezoelectric antenna provided on the dosing device.

As the transmitting and receiving transducers are excited at the same frequency, here a resonance frequency of these elements, and in a propagation medium with losses, the insertion rate characterises the capacity of the assembly to maintain the resonance at the terminals of the piezoelectric receiver at a high amplitude while the latter is charged under low electrical impedance. The highest insertion rate is sought.

The latter is measured according to the following assembly. A first piezoelectric transducer PZT1 is excited by an amplitude sinusoidal signal FEM=1 Vcc (peak-to-peak electromotive force) at a resonance frequency of the resonator. The output impedance Rs of the function generator is 50 Ohms. The transducer PZT1 converts a portion of the electrical signal into a mechanical wave which propagates to the transducer PZT2. The latter reciprocally converts the mechanical signal into an electrical signal V_{L} that is measured via an oscilloscope probe at the terminals of a resistive load of 50 Ohms.

The entry/exit insertion rate is given by the ratio

$$T I = \frac{2 {V}_{L}}{F E M} .$$

When the mechanism of coupling with the receiving transducer PZT2 is optimal, in particular, the entry/exit insertion rate can be close to the conversion rate into energy K²₃₃ of a piezoelectric transducer, which is 46% and 49% for materials PZ26 and PZ27 respectively from the Ferroperm company.

In the case where the propagation medium is heterogeneous, such as skin, fat, bone, the acoustic wave has its wave front deformed and the input/output insertion rate is degraded. This is all the more so true when the working frequency is higher.

At 1 MHz, the wavelength of the acoustic waves in the body is of a magnitude of 1.5 mm. The thickness of tissues/bone to be passed through must be thin enough and the acoustic antenna rather extended laterally so that a sufficient proportion of the power emitted is recovered.

The transmission through the walls of an enclosure for more homogeneous materials such as glass and metals pose much less problems.

Furthermore, the working frequency and the shape of the receiving antenna must make it possible to prevent the untimely couplings with other sources of acoustic waves present in the environment.

Finally, supposing that a transducer emitter having good geometry and a shape adapted to the receiving antenna contained in the dosing device is applied against the skin, it can be imagined to introduce a modulation of the signal as an activation key. The source of the acoustic wave that has to put the doser into action would for example have to be emitted at a key rate (with the key able to be changed by the patient or solely by a physician) so that the dosing device delivers the dose.

In a medium with no loss with guided propagation, when the insertion rate is good, half of the electrical power can be converted into mechanical power piezoelectrically.

### Example of an Electric Circuit

FIG. 12 shall now be referred to again in order to provide details on a particular embodiment of the control circuit 56, which is should developed next to the main figure. The excitation device 58 is a piezoelectric power transducer emitting a pressure wave in the wall 53, and taken up by the control transducer 56 and reconverted into electrical energy supplied to the electrodes of the resonator 57.

Interest here is given to a device of rather large dimensions located behind an artificial wall 53. In the power transducer 58, an unstable oscillator with a frequency of 19 kHz is used to create a high voltage of 90V by periodically opening and closing a transistor T1 which charges a self inductance of value 1 mH and series resistor 60 Ohms. The rising charge in current of the self lasts at least 40 μs (three times the time constant). During the closing of the transistor T1, a negative voltage appears and charges the tank capacitors in series arranged after the diode bridge. This high voltage is then used to excite the actuating transducer 56 at a frequency of 600 kHz by means of transistors NMOS and PMOS which switch in phase opposition, with one of them (Source), the PMOS, is used to bring the voltage of the transducer actuator to 90V while the other one, the NMOS (Sink), is used to empty the electrical charges. The two series capacitors have a combined capacity 10 to 100 times the value of the static capacity of the actuator which is approximately 100 nF. The burst at 600 kHz comprises N periods, with N between 1 and 60. The burst is re-emitted at a rate of 1 kHz in order to allow for the maintaining of the high voltage. The duty cycle for the excitation of the actuator does not exceed 10%. In the case of implantable devices, lower voltages will be used.

Particular points are:
continuous excitation in thickness mode with an excitation voltage greater than or equal to 6 Vcc of the power transducer 58 (1 to 4 MHz). It typically has a diameter from 5 to 50 mm and a thickness of 0.5 mm to 2 mm. The power transducer is positioned against the wall 57. A pressure wave is generated in the medium which propagates to the receiving transducer 56. The transmission is efficient if the two transducers have the same resonance frequency and if the excitation of the pressure wave is conducted at this frequency, and finally if the two transducers are parallel. Several tens of milliwatts are then available to the terminals of the receiving transducer 56. The excitation of the power transducer 58 can be carried out intermittently. The all-or-nothing modulation of the signal emitted according to a particular frame can be used to code a key for reactivating the doser decoded via an analogue-digital conversion A0 of the microcontroller. The latter has an analogue-digital conversion input (or via a capture/compare mode). The near-field communication (typically at a distance of 1 centimetre) is accomplished via a receiving transducer 56 identical to the power transducer 58 resonating at the same resonance frequency (1 to 4 MHz). One aspect is a dual alternating rectification of the signal received and a storing of the energy in a capacitor. While the power transducer 58 is operating, the output voltage at the terminals of the capacitor located at the output of the Schottky diode bridge rectifier increases slowly until the voltage reaches the start threshold of the microcontroller. The capacity of the capacitor at the output of the bridge rectifier 59 is sufficient to allow for a single excitation of the transducer of the resonator 57 and an operation in economy mode of the microcontroller for the counting of the time elapsed since the last dosage. The transducer of the resonator 57 cannot be reactivated before a safety delay has elapsed. In order to start a dosage operation again, on the one hand the safety delay must have elapsed, on the other hand the electric power transducer 58 against the wall 53 has to be activated. The power supply of the microcontroller is therefore carried out using the rectified piezoelectric signal. A regulator can be provided in such a way as to guarantee the supply voltage of the microcontroller and especially to guarantee the value of the excitation voltage of the transducer of the resonator 57. If it is really desired to restart the dosage operation without waiting for the safety delay, it is possible to send a reset signal to the microcontroller via the emission of an acoustic frame coded by the power transducer 58. The capture/compare mode of the microcontroller allows it to possibly read the encryption key and change the safety delay or reactivate the dosage. The microcontroller controls the opening and the closing of 2 transistors using Source and Sink signals. The transistor Pmos controls the placing in high voltage of the transducer of the resonator 57 while the other Sink signal controls the earthing of the transducer of the resonator 57 and the emptying of the electrical charges. These charging and discharging operations are carried out at a frequency of 600 kHz that correspond to the radial resonance of the resonator transducer 57. The latter can also be excited according to a bending mode thanks to the cutting of the electrode 4 into two half-rings. The electrode in contact with the tank 54 is uniform and is not used. The excitation signal is applied to these two half-electrodes located on the same surface, at the flexural resonance frequency of the sleeve 33, the transducer of the resonator 57 has a much lower thickness, typically 0.2 mm, than the power transducer 58, as the interest is simply a radial mode, but above all it is desired to impose an intense electric field and vibrate the bottom of the tank 54 according to a bending mode.

The bending mode tips the sleeve 33. This tipping generates a movement of the fluid (liquid or gel or powder) towards the exterior of the doser. The fluid is as such expulsed by the tipping and the bending movement of the end of the sleeve 33. The fact that the end of the sleeve 33 is free is critical because it is because the end of the sleeve 33 is free in relation to its base that the fluid is sucked into the capillary and expulsed towards the outside. In the case of an implementation of the dosing stylus type, a protective part of the end of the dosing tube is provided.

The bending mode of the tube is typically associated with a resonance frequency of 600 kHz.

The excitation of the actuator lasts between 10 μs and 100 μs. It is carried out when the voltage at the terminals of the rectifier capacitor located at the entrance is sufficient to wake up the microcontroller. The latter then starts its real-time clock via a 32,768 Hz quartz. The microcontroller has a frequency generator (by FLL loop) that allows it to produce the excitation signal at 600 kHz of the transducer of the resonator 57. Once the excitation of the transducer of the resonator 57 has been carried out, the microcontroller switches to low consumption mode, with the sole obligation being to measure the time elapsed since the activation of the transducer of the resonator 57. The microcontroller records in a non-volatile memory, for example its flash memory, the time elapsed since the last excitation. This allows the microcontroller at each new emission to check the value of the register and verify that the safety delay has been complied with.

### Measuring the Level in the Tank

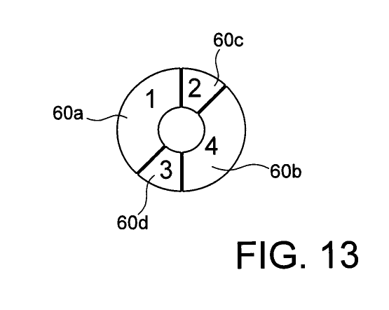

Commentary will now be made on FIG. 13. The transducers of the resonators can be in the number of four on a circle without leaving the scope of the invention. The opposite transducers 60a and 60b and extending over substantial circle sectors, close to a half-circle, have the main role of exciting the resonator and the sleeve, either in lateral bending mode, via an excitation in phase opposition, or in speaker operation mode (uniform bending resulting in a lateral displacement of the sleeve) via an excitation in phase, as has been mentioned. Two similar transducers 60c and 60d, located between the main transducers 60a and 60b, of smaller angular expansion and opposite to one another, are here used in liaison with a receiving transducer 61 opposite the resonator and therefore located in the full bottom wall of the tank (it is shown in the embodiments of FIGS. 9, 10 and 11). In a preferred embodiment, the auxiliary transducers 60c and 60d are wave emitters to this receiving transducer 61, which remains permanently in receiving mode and which measures a variation in resonance frequency, characteristic of the quantity of liquid present in the tank. With a height characteristic of the tank being of a magnitude from 5 to 10 mm, the resonance frequency λ/2 in water will be of a magnitude from 150 to 300 kH. The variation of the resonance frequency will give the indication of the height of the liquid remaining in the tank, i.e. of the volume expulsed. For a resolution of 15 Hz, the resolution on the measurement of the volume delivered will be of a magnitude of 100 nl. Still finer measurements can be taken by measuring the amplitude of the signal received for a few frequencies located on either side of the resonance peak, and finding the position of the top of the peak via quadratic interpolation.

### Biological Applications

Here now are a few particular points relating to the application of the invention to the implantation in a living body, for example in a middle ear via a surgical operation, for example, a tympanostomy.
Dosage is a slow operation that requires low to medium power. However at the time of expulsion, the power required reaches a peak value that combines a high excitation voltage at the terminals of the transducer emitter, typically of 30 V (or the maximum voltage authorised by official directives) and a substantial charge current of the piezoelectric transducer of which the static capacity can reach a few nanofarads. For switching from 0 to 30 V in 0.1 μs and a static capacity of 1 nF, the peak current reaches 300 mA (or the maximum current authorised by official directives). This operation can be carried out intermittently, for example at a rate of 1000 firings per intervals that can be programmed from one second to several hours, with each firing consisting in a burst of about thirty periods at the maximum voltage authorised at the bending resonance frequency of the bottom of the tank (out-of-plane vibration).
The resonance frequency of the actuator is typically 600 kHz, which is a period of 1.7 μs. The excitation burst is of a magnitude of about thirty periods, in such a way as to reach the maximum vibration amplitude of the bottom of the tank (which is approximately 50 μs), which sets the duty cycle to 5% for a rate of 1000 shots per second. The 95% remaining time is devoted to preparing the excitation voltage at high voltage.
The control electronics are wired on a printed circuit with a substrate made of flexible plastic of the Kapton type. The Flexible PCB is carried out with electronic components for surface assembly of which the height does not exceed 2 mm. The PCB is wound around the tank. For a tank with outer diameter 10 mm and a height of 10 mm, the Flexible PCB can occupy a surface of approximately 40 mm×10 mm.
This surface is sufficient to house therein a bridge rectifier, a regulator, a microcontroller with analogue-digital conversion that makes it possible to measure the amplitude of the signal received by the upper transducer for checking the volume of the tank, a high-voltage generator with unstable oscillator and diode bridge as well as the switching transistors for the excitation of the transducer actuator.
In order to produce an excitation voltage that corresponds to a scale for example of 30 V applied to the terminals of a transducer actuator with static capacity 1 nF at a rate of 1000 shots per second, the average need for current is 1 mA under a voltage of 3V. With elastic propagation in a guided medium, and with near field, an input/output conversion efficiency close to 50% can be obtained, i.e. retrieve 50% of the voltage of the power transducer 58 at the terminals of the receiving transducer 56, (which is under low charge impedance of 50 Ohms) after propagation in the medium. In a heterogeneous medium such as the dermis and skin, a conversion efficiency through the dermis of 10% makes it possible to estimate the excitation voltage at the terminals of the power transducer 58 in order to have the power available on receiving transducer 56. If 6 Vcc is desired at the terminals of the latter, 12 Vcc is needed at the terminals of the power transducer 58 with an efficiency of 50% or 60 Vcc with an efficiency of 10%.
In the absence of the power transducer 58, supplying the required electrical power, there is no way to activate the doser. The average acoustic powers in play are also weak and the working frequencies are high in such a way that there is no physiological risk other than the risk of a hearing discomfort during the activation of the doser. There could be hearing discomfort if the excitation signal of the transducer of the resonator 57 included energy in the audible band. For this it is provided that the burst is at a frequency much higher than the limit of the audible spectrum, which here is 600 kHz. Furthermore, the excitation signal could be symmetrical (this is not the case here because there is only one high voltage, for example, 90 Volts with open circuit: the firing oscillates therefore as a burst comprising N pulses between 0 and +90 volts re-emitted at a rate of 1 kHz; this frequency risks being strongly perceived inside the ear) by providing a second high voltage symmetrical of the first and an actuating of the transducer of the resonator 57 between +90V and −90V (open circuit) and +30V to −30V (charged by the transducer). Finally, when the burst comprises a sufficient number of pulses (N>10), the audible noise of the intermittent excitation burst can be reduced further by the application of a burst apodisation window (Hamming, Hanning or Blackman weighting).
Contrary to the receiving transducer 56, the transducer of the resonator 57 must be able to be excited with an electric field that is as high as possible, i.e. about 400 to 500 V/mm for PZT ceramics. This requires choosing a transducer with low thickness, typically 0.1 mm to 0.2 mm. This has two advantages:
the transducer can easily bend and be deformed according to a mode allowing for the transfer of the fluid to the output of the closer;
the excitation voltage can remain low, of a magnitude of a few volts for implantable and from 10 V to 30 V for non-implanted applications.

The receiving transducer 56 will transfer the energy to the resonator 57 via a wire covered with silicone. No magnet is used, with the advantage of not disturbing magnetic resonance imaging for clinical applications.

The excitation of the electrodes for the speaker mode, via an axial movement of the ring of the resonator, can allow the dosing device to also be used as a hearing aid, by reconstructing an analogue signal at the hearing frequencies inside the ear by a modulation of the beats of the ring of the resonator. The volume delivered can be determined in an open loop and therefore modified according to the needs at the time, in a therefore controlled and perfectly reliable manner. The increase in temperatures produced by the pump of the invention is greatly reduced. The pump can be implanted according to a cochlear implant technique in the middle ear; the use of the outlet hose of FIG. 4 for example makes it possible to inject the fluid into the inner ear or to deposit drops on the membrane of the round window in a manner that is non-invasive for the inner ear (the cochlea), with this last option being preferred as the inventors feel that it is less risky for the residual hearing of the patient. The leakage rate is zero, and the pump is not sensitive to the backflow of liquid. No moving mechanical parts are used. The main tank can be very flat, a few millimetres thick for a diameter of a magnitude of the centimetre, or on the contrary the device can be placed in an element separate from the tank, that is connected to it for example by a cannula that can be thin or extended (for example 5 mm in diameter or more and a length of a magnitude of a centimetre or more). The use of ultrasound makes the invention silent. Extraction is facilitated if on the bending movement at the resonance frequency f₀ of the resonator a movement is superimposed out of the plane of the resonator (in speaker mode) at the dual frequency 2f₀, which generates a peristaltic movement of the internal surface of the dosage sleeve.

The acceleration required for the flow and for the dosage of the product is of several thousands of “g”: the accelerations that are normally encountered, of a few “g” at most, cannot under any circumstances induce leakage.

The device, which is devoid of moving mechanical parts and materials that can degrade rapidly under mechanical stress, such as polymers, ages well.

It is possible to work with intermittent operation or on the contrary continuously or quasi-continuously, with a precise direction of the stream.

If an important application is the use as an implantable device for dispensing drugs (DDS category “Drug Delivery System”), others can also be considered just as easily, such as inking pens or deodorising devices or industrial dosage of 1 or 2 compounds or reagents on a float in particular.

1-26. (canceled)

27. A pump for injecting a fluid, comprising:
a tank of fluid;
a sleeve for flow of the fluid outside of the tank; and
a device for controlling the flow, comprising a resonator configured to apply flexural ultrasound oscillations to the sleeve,
wherein the resonator comprises a piezoelectric transducer and a piezoelectrically deformable solid that is subjected to an oscillation under effect of the transducer, the deformable solid thinning towards the sleeve.

28. A pump for injecting a fluid according to claim 27, wherein the sleeve constantly tapers as section from the tank to a free end.

29. A pump for injecting a fluid according to claim 27, wherein the piezoelectrically deformable solid is a ring surrounding the sleeve, and the transducer is circular and divided into two sectors supplied by a same oscillating electric signal, but in phase opposition.

30. A pump for injecting a fluid according to claim 29, wherein the ring is connected to the sleeve.

31. A pump for injecting a fluid according to claim 30, wherein the ring is connected to the sleeve by a tubular section surrounding the sleeve and extending from the ring towards a free end of the sleeve.

32. A pump for injecting according to claim 27, wherein the sleeve tapers towards its free end.

33. A pump for injecting according to claim 29, wherein the ring thins radially towards the sleeve.

34. A pump for injecting according to claim 29, wherein the ring is part of a surface of the tank to which the sleeve is fixed.

35. A pump for injecting according to claim 27, wherein the sleeve carries a nozzle tapered at its free end.

36. A pump for injecting according to claim 27, further comprising a flexible outlet tube surrounding the sleeve, wherein the sleeve opens, which comprises a free end that has an opening outside of the pump with reduced section in relation to a main portion of the flexible tube that contains the sleeve, and the resonator is configured to apply flexural oscillations also to the flexible tube.

37. A pump for injecting according to claim 30, wherein the sleeve is connected to the tank by a hose.

38. A pump for injecting according to claim 30, wherein the sleeve comprises two portions as a protruding extension on either side of the ring, dissymmetrical, and the capillary passes through both of the two portions.

39. A pump for injecting according to claim 30, wherein the sleeve comprises two portions as a protruding extension on either side of the ring, dissymmetrical, and the capillary passes through both of the two portions, and a middle portion joining the protruding portions, and the resonator further comprises two portions which are dissymmetrical and superimposed, respectively connected to the protruding portions and between which the middle portion extends.

40. A pump for injecting according to claim 38, further comprising at least one flexible tube each surrounding portions of the sleeve, which open therein respectively, each of the flexible tubes comprising a free end having an opening respectively outside of the pump and in the tank, with the opening having a reduced section in relation to a main portion of the flexible tube that contains the portion of the sleeve, and the resonator is arranged to apply flexural oscillations also to each of the flexible tubes.

41. A pump for injecting according to claim 29, further comprising a device for measuring a level of fluid in the tank.

42. A pump for injecting according to claim 41, wherein the device for measuring the level of fluid comprises two sectors of the transducer, and a receiving transducer located at a location of the tank opposite the resonator.

43. A pump for injecting according to claim 31, wherein a surface of the tank to which the sleeve is fixed is conical such that the tank is convex, and a membrane extends in the tank by separating the fluid from the surface.

44. A pump for injecting according to claim 43, further comprising a valve free between a piercing of the membrane facing the sleeve and an end of the sleeve opening into the tank.

45. A pump for injecting according to claim 27, further comprising a cover with an edge attached to the tank, covering the sleeve and including an orifice in front of a free end of the sleeve.

46. A pump for injecting according to claim 45, wherein the orifice of the cover contains a free ball in a housing constituting the orifice.

47. A pump for injecting according to claim 45, wherein the cover delimits a housing forming a reserve for an additive to the fluid.

48. A pump for injecting according claim 27, wherein the resonator is configured to also apply axial oscillations to the sleeve.

49. A pump for injecting according to claim 48, wherein the axial oscillations have a dual frequency of the flexural oscillations.

50. A pump for injecting according to claim 48, further comprising a needle fixed to the tank and extending in a capillary.

51. A pump for injecting according to claim 27, further comprising a power transducer converting an electrical energy into longitudinal waves in an adjacent medium, a receiving transducer also adjacent to the medium, converting the longitudinal waves into electrical energy and fixed to the tank, and connected to the resonator to control the resonator.

52. A pump for injecting according to claim 27, wherein a capillary is always open.
